(19) United States
(12) Patent Application Publication
(10) Pub. No.: US 2019/0292085 A1
(43) Pub. Date: Sep. 26, 2019

(54) GLASS FORMING APPARATUS

(71) Applicant: PYROTEK, INC., Spokane, WA (US)

(72) Inventors: Rickie L. Retorick, Snow Shoe, PA (US); Timothy E. March, Carlisle, PA (US); John A. Pokrzyk, JR., Boiling Springs, PA (US); Mark Palmer, Spokane, WA (US)

(73) Assignee: PYROTEK, INC.

(21) Appl. No.: 16/275,940

(22) Filed: Feb. 14, 2019

Related U.S. Application Data
(63) Continuation-in-part of application No. 15/015,772, filed on Feb. 4, 2016, now abandoned.
(60) Provisional application No. 62/111,777, filed on Feb. 4, 2015.

(51) Int. Cl. C03B 7/088; C03B 7/086

(52) U.S. Cl. CPC C03B 7/088; C03B 7/086

(57) ABSTRACT

A refractory orifice ring of a glass forming apparatus. The orifice ring includes an annular side wall and a base wall. At least one discharge hole is formed in the base wall. The discharge hole includes a top opening and a bottom opening, wherein the top opening has a surface area greater than a surface area of the bottom opening.

This application claims the benefit of U.S. Provisional Application Ser. No. 62/111,777, filed Feb. 4, 2015, and U.S. patent application Ser. No. 15/015,772, filed Feb. 4, 2016, the disclosures of which are hereby incorporated by reference.

### BACKGROUND

The present disclosure relates to feeders for delivering vertical runners of molten glass to a shear mechanism which severs the runners into discrete gobs for distribution to a glass container forming apparatus. The present disclosure more particularly relates to the refractory orifice ring for such apparatus which has one or a plurality of holes distributing a corresponding number of continuous runners of molten glass to the shear mechanism.

Glass feeders are shown in U.S. Pat. Nos. 4,554,000 and 4,999,040, the disclosures of which are herein incorporated by reference. Such feeders have a spout bowl which has a cylindrical vertical outlet at the bottom. This cylindrical outlet is closed by a circular orifice plate which has one, two, three or four in-line holes through which the glass passes. Plungers, corresponding in number and location to the holes in the orifice plate, are located within the cylindrical outlet and reciprocate vertically to form the runners as they are sheared into the gobs.

With specific to FIGS. 1-3, an exemplary prior art glass forming mechanism is illustrated. Particularly, molten glass 10 is contained in a spout bowl container defined by a refractory bowl 12 and a refractory tube 14 which surrounds a plurality of plungers 16. The lower ends 18 of the plungers 16 cooperate with an orifice plate 20 to allow runners of molten glass to be delivered to a shear mechanism 22. This shear mechanism shears the runners into discrete gobs which are fed to individual sections of a glassware forming machine (not shown).

The orifice ring 20 has a plurality of holes 32. The side wall 34 of the orifice plate extends from a top edge 36 to bottom outside edge 38 which intersects a bottom wall 40. The bottom wall 40 of the orifice plate has a uniform thickness where it joins the side wall, except where a pair of parallel strengthening ribs 42 are located. These strengthening ribs extend perpendicular to the array of holes 32 from one side of the orifice plate to the other, and merge with the sidewall 34 to define localized areas 33 at the periphery of the orifice plate. Grooves 44 are defined in these strengthening ribs to receive cooling tubes (not shown) which maintain constant temperature across each hole.

The present disclosure is particularly directed to an improved orifice ring construction that provides improved life and reduced variation in gob size.

### BRIEF DESCRIPTION

The function of the orifice ring is to control the diameter of the molten glass gob and the number of gobs required for the particular glass operation. The orifice ring is typically circular or elliptical and contains the appropriate number of gob holes, normally from one to four holes, centrally located in the orifice ring. The orifice ring is installed in the bottom of a spout. The molten glass is forced through the holes in the orifice ring by means of mechanical force from plunger(s) located above the orifice ring.

Failure of the orifice ring can affect the glass in several significant ways. First, a fissure can score the surface of the glass and pass an imperfection on to the finished product. Second, a faulty orifice ring can allow the molten glass to leak from the feeder. Third, variation in gob weight delivered by the orifice ring can cause variation in the resultant product and potentially unacceptability. These are each serious problems that can be expensive if they remain undetected. Failure also, of course, causes production time to be lost while the orifice ring is replaced and the system returned to normal.

According to a first embodiment, a refractory orifice ring of a glass forming apparatus is provided. The orifice ring has an annular side wall, and a base wall. At least one discharge hole is formed in the base wall. The discharge hole has a top opening and a bottom opening, wherein the top opening includes a surface area which is larger than a surface area of the bottom opening.

According to a second embodiment, a refractory orifice ring of a glass forming apparatus is provided. The orifice ring includes an annular side wall and a base wall. At least one discharge hole is formed in the base wall. The discharge hole includes a top opening and a bottom opening, wherein the top opening has a width at its smallest dimension which is greater than a width of the bottom opening at its largest dimension.

According to a further embodiment, a refractory orifice ring of a glass forming apparatus is provided. The orifice ring includes an annular side wall and a base wall. At least two discharge holes are formed in the base wall. The discharge holes have an oval top opening and a circular bottom opening. The top opening has surface area which is larger than a surface area of the bottom opening.

The present inventive orifice ring has been found to improve operational longevity by providing a longer throat hole which wears top down. The present inventive orifice ring has also been found to reduce gob weight variation by between about 20 and about 50 percent.

### BRIEF DESCRIPTION OF THE DRAWINGS

FIG. 1 is an elevational, cross-sectional view of a prior art glass feeder taken from side to side;

FIG. 2 is an elevational, cross-sectional view of the glass feeder at 90° from the view shown in FIG. 1;

FIG. 3 is an oblique view looking downwardly into the spout bowl of the glass feeder of FIG. 1;

FIG. 4 is a perspective view of the orifice ring of the present disclosure prior to discharge hole drilling;

FIG. 5 is a perspective view of the orifice ring of FIG. 4 subsequent to drilling of a reduced diameter discharge hole;

FIG. 6 is a perspective view of the orifice ring of FIG. 4 subsequent to drilling of a full diameter discharge hole;

FIG. 7 is a top plan view of the orifice ring of FIG. 6;

FIG. 8 is a cross-section view taken along line 8-8 of FIG. 7;

FIG. 9 is a cross-section view taken along line 9-9 of FIG. 7;

FIG. 10 is a cross-section view taken along line 10-10 of FIG. 7;

FIG. 11 is a top plan view of an alternate embodiment of an orifice ring;

FIG. 12 is a cross-section view taken along line 12-12 of FIG. 11;

FIG. 13 is a cross-section view taken along line 13-13 of FIG. 11; and

FIG. 14 is a top side perspective view of an alternative embodiment orifice ring;

FIG. 15 is a bottom side perspective view of the orifice ring of FIG. 14;

FIG. 16 is a top plan view of the orifice ring of FIG. 14;

FIG. 17 is a bottom plan view of the orifice ring of FIG. 14;

FIG. 18 is a cross-sectional view of the orifice ring taken along line 18-18 of FIG. 16;

FIG. 19 is a cross-sectional view of the orifice ring taken along line 19-19 of FIG. 16

FIG. 20 a top side perspective view of an alternative orifice ring;

FIG. 21 is a bottom plan view of the orifice ring of FIG. 20; and

FIG. 22 is a cross-sectional view of the orifice ring taken along line 22-22 of FIG. 21.

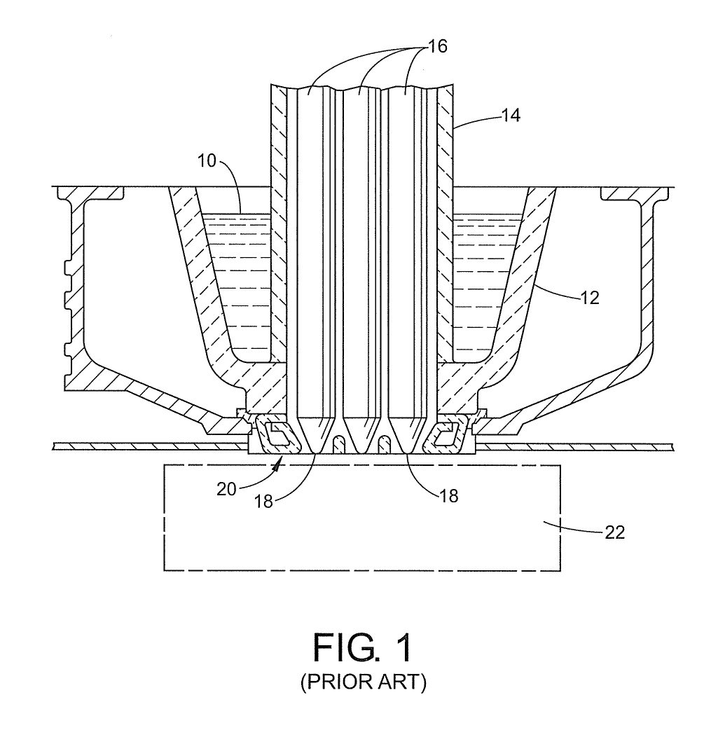

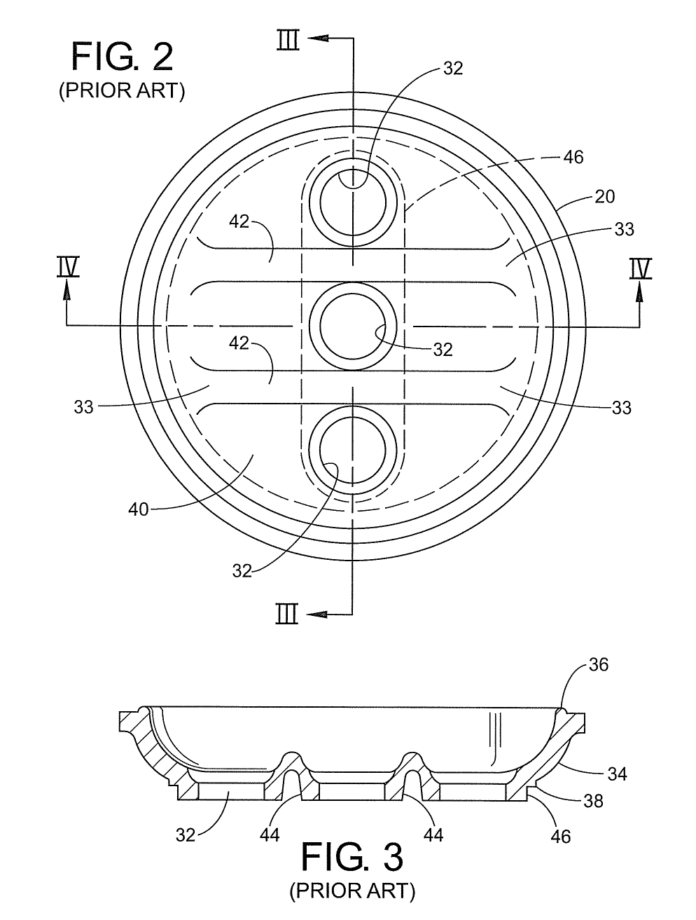

### DETAILED DESCRIPTION

As used herein the terms “about” and “substantially” are intended to encompass a variation which does not negatively effect the performance of the element with which the term is associated.

A typical orifice ring will be constructed of a high purity refractory composition of alumina-zirconia-silica such as Pyroguard Wearshield Z200 available from Pyrotek Inc. Of course, alternative refractory materials known to the skilled artisan are equally suitable for use in the present orifice ring construction.

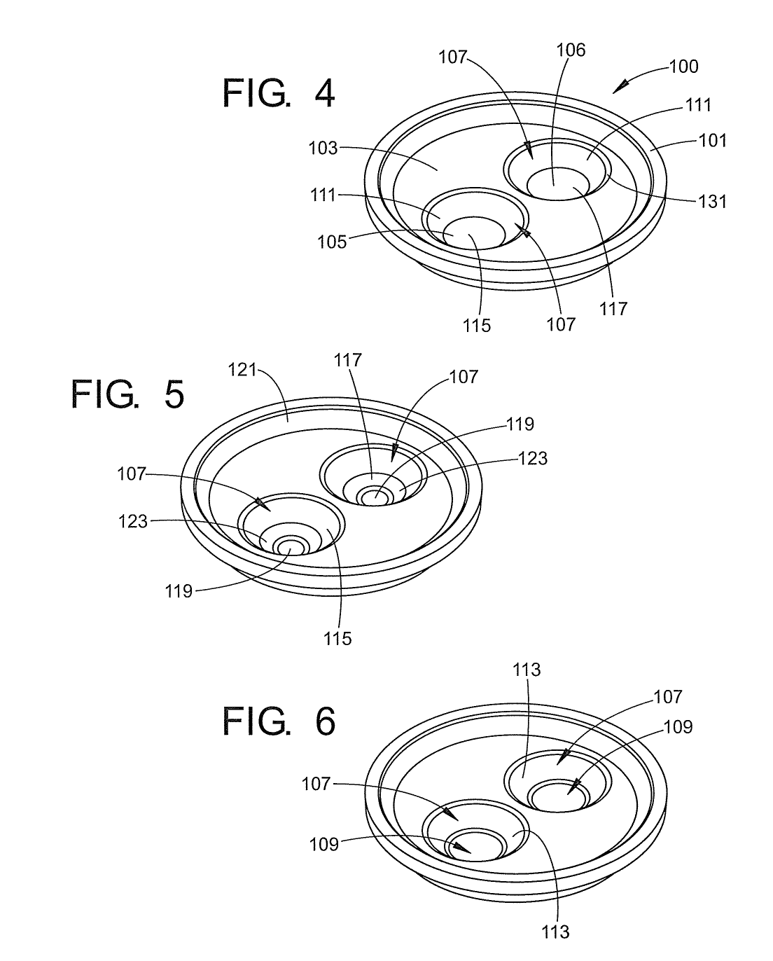

Referring now to FIGS. 4-10, the orifice ring 100 of the present disclosure includes an annular side wall 101 and a planar base wall 103. A pair of discharge holes 105 and 106 are formed in the base wall. It is noted that with respect to FIG. 4, the discharge holes have not yet been fully formed by drilling through the base wall 103.

Each of the discharge holes 105 and 106 can have a top opening 107 and a bottom opening 109. The top opening 107 is configured to be of a larger dimension than the bottom opening 109. In this regard, although the depicted discharge hole is circular at both the top and bottom opening, it is envisioned that different geometric configurations could be employed. For example, a circular top opening could be employed with an elliptical bottom opening. Moreover, the specific shape of the openings is not intended to be limiting provided the surface area of the bottom opening is smaller than the surface area of the top opening (i.e. the discharge hole has a narrowing between top opening and bottom opening).

Although the holes can be configured in any shape desired by the skilled artisan, in the depicted design the top opening and bottom opening are each circular in cross-section. This configuration, in combination with the inwardly slanted side wall 111 combines to form a discharge hole 105 having a shape in the form of a truncated cone 113 (see FIGS. 8 and 9).

The orifice ring 100 can generally be formed by casting. The cast body, as shown in FIG. 4, may include a partially formed discharge hole 105. Moreover, portions 115 and 117 can be retained in base wall 103 for subsequent removal by, for example, drilling.

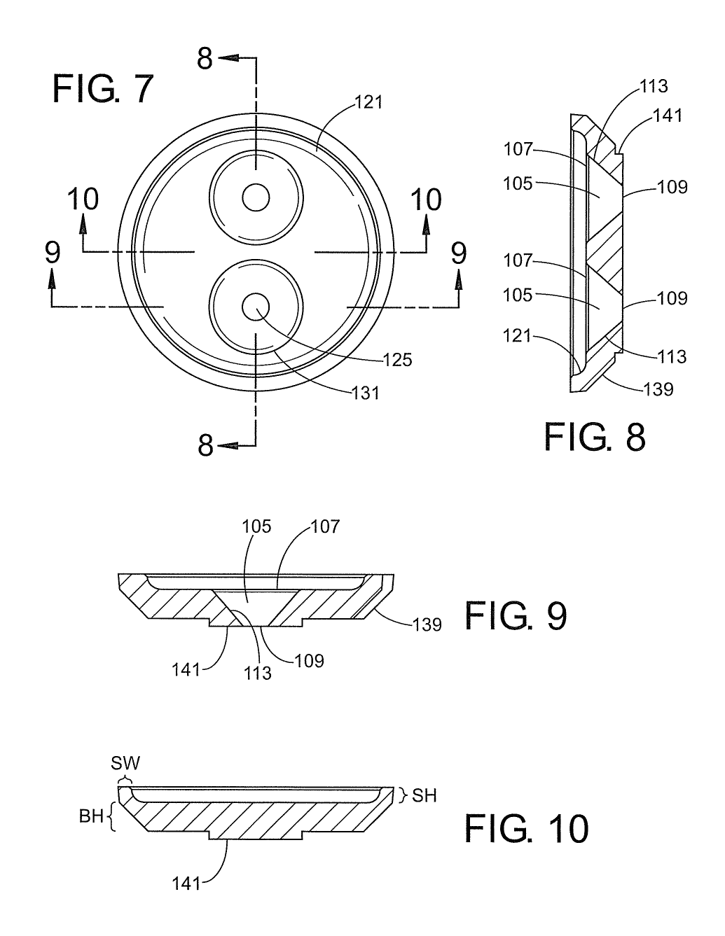

With reference to FIG. 5, this allows for the creation of a relatively smaller bottom opening 119 and a remaining ledge 123 to be provided. Moreover, the diameter of the bottom opening (see arrow 125 in FIG. 7) can be selected after casting. In this manner, the diameter 125 of the discharge hole bottom opening 109 is tailorable based on the requirements of the end user.

In the embodiment of FIGS. 6-10, the bottom opening 109 is opened to its full extent, i.e. to the side wall 111 forming truncated cone 113, and thus no ledge remains.

To provide a suitably robust orifice ring, it is contemplated that the base wall 103 will have a height BH greater than a height SH and width SW of the corresponding annular side wall (see FIG. 10). It is also contemplated that this configuration provides improved longevity of the orifice ring as wear thereof is greatest in the base wall and develops primarily in a top down manner.

To further improve performance and longevity, it may be desirable to provide the inner surface 121 of the annular side wall 101 with an inward slope as it approaches the base wall 103. It may similarly be desirable to provide the corner forming the intersection between the inner surface 121 of the annular side wall 101 and base wall 103 with a filleted or chamfered shape. Similarly, it may be desirable to form the corner 131 between base wall 103 and wall 111 forming discharge hole 105 with one of a chamfered and/or radiused shape.

For ease of construction, the exterior surface 139 of the base wall 103 may be similarly constructed with a truncated cone configuration. It is also observed that longevity of the orifice ring may be improved by providing a neck 141 adjacent to the bottom opening 109 of the discharge hole 105.

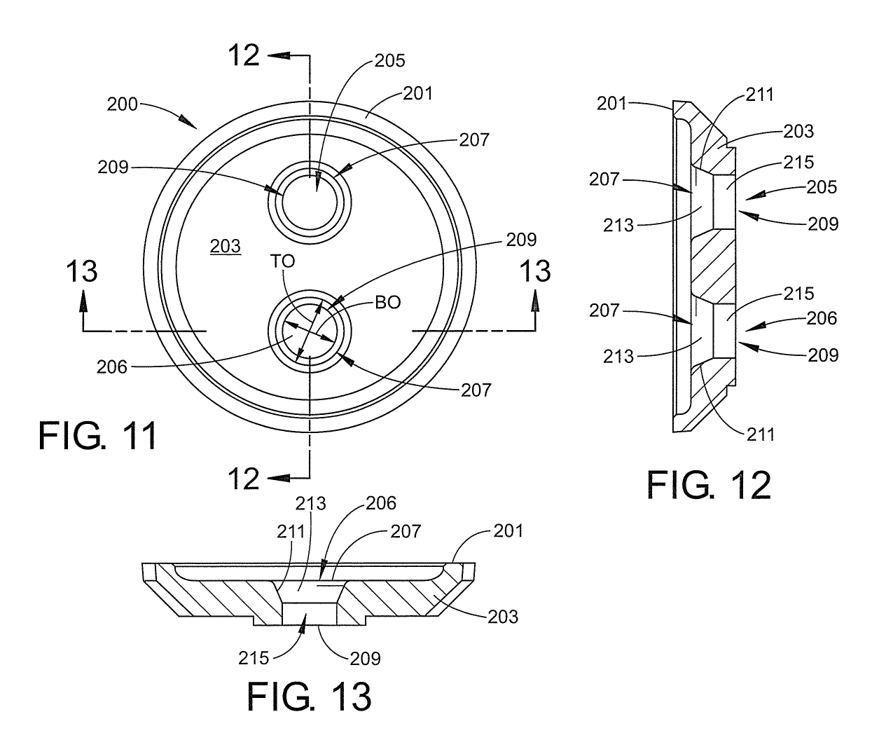

With reference now to FIGS. 11-13, an alternative embodiment of the inventive orifice ring is depicted. Particularly, orifice ring 200 includes annular side wall 201 and planar base wall 203. A pair of discharge holes 205 and 206 are formed in the base wall 203. Each of the discharge holes 205 and 206 have a top opening 207 and a bottom opening 209. Each of the discharge holes 205 and 206 are formed with an inwardly slanted side wall 211 forming a truncated cone section 213. In this embodiment, rather than extending fully through base wall 203, truncated cone section 213 intersects a cylindrical passage 215 leading to bottom opening 209. This embodiment nonetheless provides a top opening 207 with a larger surface area than the bottom opening 209. This is illustrated by the wider diameter at line “TO” associated with the top opening 207 relative to the narrower diameter at line “BO” associated with bottom opening 209 (see FIG. 11). The embodiment of FIGS. 11-13 also illustrates that the discharge hole is not required to have a constant change of dimension between the top and bottom openings. Rather, the advantages of the design can be achieved by any shape of openings and sidewall provided the top opening provides a larger cross-section than the bottom opening.

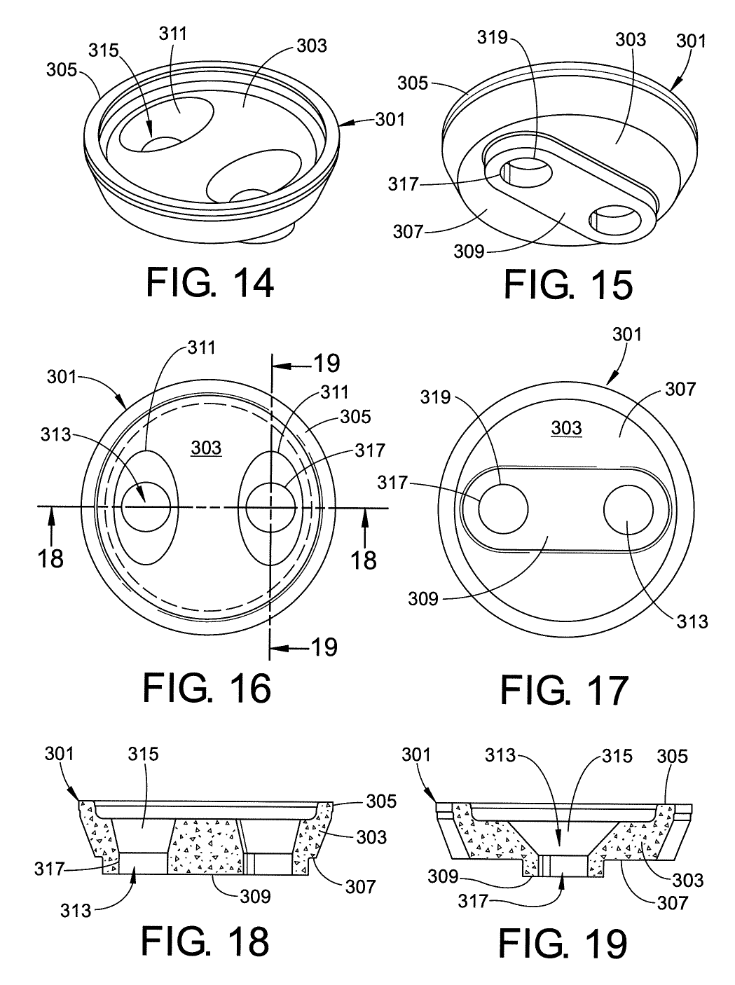

With reference to FIGS. 14-19, a further alternative embodiment of the inventive orifice ring is illustrated. The orifice ring 301 of this embodiment is similar in certain respect to the previous embodiments. For example, orifice ring 301 includes a base wall 303 and an annular side wall 305. The bottom side 307 of base wall 303 further includes a neck element 309. In this embodiment, the opening 311 to passage 313 is oval in shape. The opening 311 transitions to a truncated ovoid passage 315 that mates with a cylindrical passage 317. Cylindrical passage terminates in a circular bottom opening 319. Although variation is feasible, the depicted configuration places the ovoid passage 315 in the base wall 303 and the cylindrical passage in the neck element 309.

This design is beneficial because it allows the opening to have a larger surface area than the outlet while positioning the material removed to form the opening laterally. This avoids creating a zone of orifice ring weakness between the two passages.

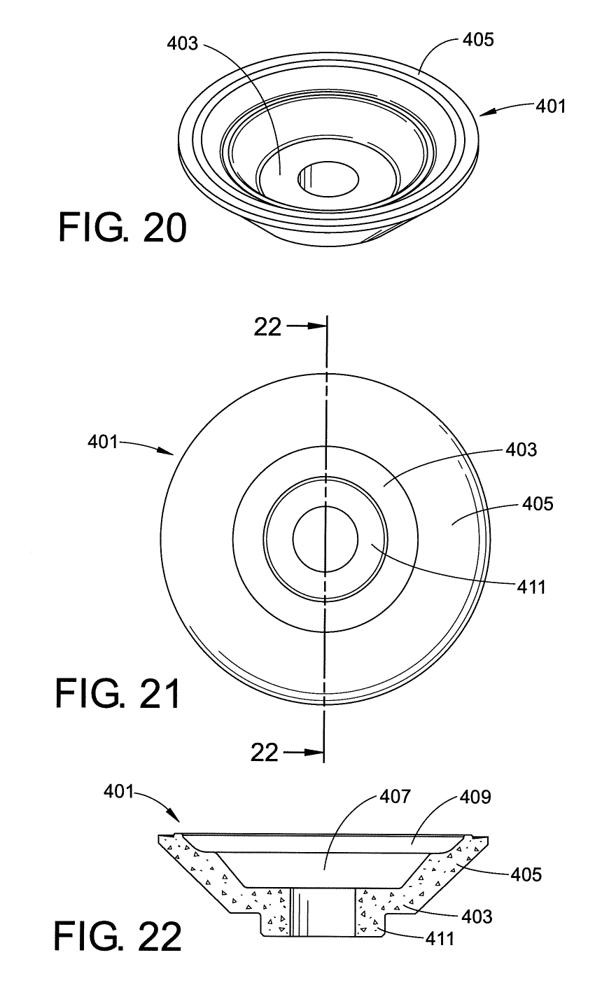

With reference to FIGS. 20-22, an additional alternative embodiment of the inventive orifice ring is illustrated. Particularly, a single passage configuration is depicted. Orifice ring 401 includes a base wall 403 and an annular side wall 405. In this embodiment, the reservoir formed by the annular side wall 405 includes a first narrow region 407 and a second wider region 409. Similar to the prior embodiment, orifice ring 401 includes neck element 411.

The exemplary embodiment has been described with reference to the preferred embodiments. Obviously, modifications and alterations will occur to others upon reading and understanding the preceding detailed description. It is intended that the exemplary embodiment be construed as including all such modifications and alterations insofar as they come within the scope of the appended claims or the equivalents thereof.

1. A refractory orifice ring of a glass forming apparatus, said orifice ring comprising:
an annular side wall and a base wall, said base wall having a planar top surface interrupted only by at least two discharge holes, said annular side wall extending from said base wall to form a reservoir,
said discharge holes having a top opening and a bottom opening, wherein said top opening includes a surface area which is larger than a surface area of said bottom opening, wherein a sidewall extends between the top opening and the bottom opening, said sidewall comprising a truncated cone having a constant slope between the top opening and the bottom opening.

2. The orifice ring of claim 1, wherein said base wall includes a bottom surface, said bottom surface including a single projecting neck element, said neck element surrounding each of said discharge holes bottom opening and wherein said holes define an axis and said neck element includes a length on the axis, said length being greater than a width of the neck element.

3. The orifice ring of claim 3, wherein said top opening and said bottom opening are circular.

4. The orifice ring of claim 1, wherein said base wall has a height adjacent said discharge holes greater than a height of said annular side wall.

5. The orifice ring of claim 1, wherein said base wall has a height adjacent said discharge holes greater than a width of said annular side wall.

6. The orifice ring of claim 1, wherein an inner surface of said annular side wall is inwardly sloped as said side wall approaches said base wall.

7. The orifice ring of claim 1 being one of circular and elliptical in cross-section.

8. The orifice ring of claim 1, wherein said orifice ring is comprised of a refractory material.

9. The orifice ring of claim 1, wherein a corner between said base wall and said discharge hole is one of chamfered and radiused.

10. The orifice ring of claim 1, wherein a corner between said annular sidewall and said base wall is one of chamfered and filleted.

11. The orifice ring of claim 1, wherein an exterior surface of said base wall comprises a truncated cone.

12. A glass feeding apparatus comprising:
a spout bowl configured to contain molten glass and including a neck portion at a bottom, the neck portion including a vertical passage extending therethrough from an upper inlet opening to a lower outlet opening, the orifice ring of claim 1 disposed at the lower outlet opening, and at least one plunger.

13. A refractory orifice ring of a glass forming apparatus, said orifice ring comprising:
an annular side wall and a base wall, said base wall having a planar top surface interrupted only by a discharge hole, said annular side wall extending from said base wall to form a reservoir,
said discharge hole having a top opening and a bottom opening defining a length therebetween, wherein said base wall includes a bottom surface, said bottom surface including a single projecting neck element, said neck element surrounding said discharge hole bottom opening, wherein a depth of said reservoir is less than the length of said discharge hole.

14. The orifice ring of claim 13, wherein said top opening includes a width at a smallest dimension greater than a width of said bottom opening at a largest dimension.

15. The orifice ring of claim 13 including two discharge holes, wherein each of said discharge holes is spaced inwardly from the annular side wall such that a portion of said planar top surface extends therebetween.

16. The orifice ring of claim 15, wherein said base wall is a monolithic body having its greatest thickness on an axis defined by said discharge holes.

17. A refractory orifice ring of a glass forming apparatus, said orifice ring comprising:
an annular side wall and a base wall, at least two discharge holes formed in said base wall,
said discharge hole having a top opening and a bottom opening,
said top opening including a surface area which is larger than a surface area of said bottom opening, and
said top opening being at least substantially oval and said bottom opening being at least substantially circular.

18. The orifice ring of claim 17, wherein each oval includes a long axis and the long axes are parallel.

19. The orifice ring of claim 17, wherein an outer edge of each oval is closer to said annular side wall than to the outer edge of another discharge hole.

20. The orifice of claim 17, wherein said base wall includes a bottom surface having a neck projecting therefrom, and wherein said oval opening comprises a truncated ovoid extending through the base wall and mating with a cylinder extending through the neck and forming the circular opening.
